(19) United States
(12) Patent Application Publication
(10) Pub. No.: US 2004/0179848 A1
(43) Pub. Date: Sep. 16, 2004

(54) Scintillation free laser communication system

(76) Inventor: Mikhail Belenkii, San Diego, CA (US)

Correspondence Address: John R. Ross, Ross Patent Law Office, P.O. Box 2138, Del Mar, CA, 92014, US

(21) Appl. No.: 10/386,297

(22) Filed: Mar. 11, 2003

(51) Int. Cl. H04B 10/00

(52) U.S. Cl. 398/131

(57) ABSTRACT

A laser communication system with improved reliability and exceptionally low bit error rate. The proposed laser communication system completely eliminates the effects of turbulence and provides free space performance. In addition, in the case of a modulatable retro-reflector the proposed system minimizes laser energy loss. These objectives are achieved by transmitting a focused laser beam to a receiver so that the focused beam waist is located entirely within the aperture of the receiver where the aperture size exceeds the effective spot size of the beam including effects of diffraction, atmospheric turbulence, and beam pointing error. In a preferred embodiment an imaging tracker at the transmitter and a laser beacon with a diverging beam at the receiver permits the transmitter to point a focusing beam accurately enough to assure that the entire beam is captured in the receiver aperture. In another embodiment a laser beam is transmitted from a first location to a modulatable retro-reflector at a second location. The beam transmitted from the first location is focused within the aperture of the retro-reflector. This beam may be sampled at the second location for communications from the first location to the second location. The retro-reflector is modulated for transmission of information from the second location to the first location.

The present invention relates to communication equipment and processes and especially to laser communication equipment and processes.

### BACKGROUND OF THE INVENTION

### Laser Communication Systems

Laser communication systems have several principal advantages, as compared to wireless RF communication:

a) They provide a higher degree of security and low probability of detection because very little radiation occurs outside of the communication channel so that these links are safe from interception.

b) They provide a direct link to the existing fiber optic communication network.

c) They can be used for ground-to-ground, ground-to-air, air-to-air, ground-to space and space-to-ground communication links.

d) They are attractive for military and civilian deep space communication, due to the small beam divergence the laser beam.

e) They do not require FCC spectrum allocation or an installed communication channel infrastructure such as fibers.

f) They are easy to set up and remove.

The main shortcoming of laser communication systems is that the atmosphere can severely degrade their performance due to a) attenuation of the laser irradiance, and b) signal fading on the detector caused by turbulence-induced scintillation that produces errors in data transmission.

FIG. 1 depicts the bit error rate (BER) in a fading channel with white Gaussian noise and log-normal intensity probability distribution caused by turbulence. Here σ_{I}² is the Rytov variance that characterizes the strength of turbulence-induced scintillation. The chart shows that the bit error rate y increases with increasing the scintillation and decreasing signal to noise ratio (SNR). In particular, in a free space (σ_{I}²=0) BER=10⁻⁹ is achieved when SNR=12. For stronger turbulence and the same SNR, BER increases up to 0.05. In the presence of very strong turbulence (σ_{I}²=1.66) the minimum bit-error-rate is only BER=10⁻⁷ when SNR=10³. Thus, the scintillation greatly degrades the performance of the laser communication system. This degradation effect cannot be compensated for, even by increasing the laser power and SNR by several orders of magnitude.

### State of the Art

Different methods have been proposed to mitigate the effects of scintillation on the laser communication links. They include the use of

a) a large aperture telescope,

b) a multiple beam illuminator (multiple transmitting beams), and

c) other methods including a diffuser to create a partial-coherence beam, an adaptive threshold; and special data communication coding techniques.

Now we will briefly review these methods

a) Aperture Averaging

When the receiver diameter exceeds the intensity correlation scale in the incoming wave, D/lₛ>1, the signal variations on the detector caused by scintillation are reduced. The latter is because the received signal is a spatial average over the large aperture area. The aperture includes a large number of bright and dark turbulence-induced speckles, which compensate each other. According to [1]V. Tatarskii, Wave Propagation in Random Medium (McGraw-Hill, New York, 1961) and [2]D. Fried, “Aperture averaging of scintillation,” JOSA, Vo. 57, 169-175(1967), the scintillation variance in a weak scintillation regime decreases with aperture diameter D as G(D/lₛ)∝(D/lₛ)^{-7/3}, where l_{I} is the intensity correlation scale in the incoming wave. In a weak scintillation regime l_{I}=\sqrt{λL}, where λ is the wavelength, and L is the path length. In the strong scintillation regime l_{I}=r₀/2.1, where

$${r}_{0} = {( 0.423 {k}^{2} {\int }_{0}^{L} {C}_{n}^{2} ( z ) ⅆ z )}^{- 3 / 5}$$

is the coherence diameter, or Fried parameter, k=(2λ/λ) and Cₙ² is the refractive index structure characteristic.

This method has several shortcomings. First, it requires a large aperture telescope, which is not feasible in the case of a flying platform. Second, it provides only partial reduction of scintillation and does not allow us to achieve a free space performance. Third, this method is inefficient in the case of a retro-reflector, or modulating retro-reflector developed by researchers at the NRL ([3]Gilbreath, G. C., Rabinovich, W. S., Vilcheck, T. J., Mahon, R., Burris, R., Ferraro, M., Sokolsky, I., Vasquez, J. A., Bovais, C. S., Cochrell, K., Goins, K. C., Barbehenn, R., Katlzer, D. S., Ikossi, K., Anastasiou, Montes, M. J., “Large-aperture multiple quantum well modulating retroreflector for free-space optical data transfer on unmanned aerial vehicles,” Opt. Eng., Vol. 40, 1348-1356(2001)).

A modulating retro-reflector permits two-way communication between the ground station and a flying platform, such as UAV, or between two flying platform by using just one laser, one telescope, and one pointer/tracker, whereas typical systems require two lasers, two telescopes, and two pointer/tracker systems. In this concept a semiconductor-based multiple quantum well shutter capable to modulate laser return at a rate greater than 10 Mbps (megabits per second) is used. This device is compact, lightweight, covert, and requires very low power. However, a conventional method of averaging of turbulence-induced scintillation by using a large aperture telescope cannot be used in the case of a modulating retro-reflector because of a residual turbulent scintillation (RTS) effect.

The RTS effect ([4] M. S. Belen'kii, “Effect of residual turbulent scintillation and a remote-sensing technique for simultaneous determination of turbulence and scattering parameters of the atmosphere,” JOSA A, Vol. 11, p. 1150-115(1994)) is illustrated in FIG. 2. Here curves 1 and 2 correspond to experimental data recorded in a reflected beam, when the reflector size is less, or comparable, to the intensity correlation scale in the incoming wave l_{R}≦l_{Is}. Curve 3 represents the theoretical prediction for the conventional aperture averaging function on a one-way propagation path from [2]. It is seen that the aperture averaging function in a reflected wave (curves 1 and 2) saturates at the constant level, and it does not depend on the receiver aperture diameter, whereas the aperture averaging function on a one-way propagation path (curve 3) gradually decreases with increasing the aperture diameter D=2R normalized to the intensity correlation scale l_{Is}=\sqrt{λL}. The latter is because when a_{R}≦l_{I} the intensity fluctuations in the incoming wave modulate the total reflected energy flux. Consequently, intensity fluctuations of a reflected wave are correlated at all points of the receiver plane, and they are not averaged out by a receiving aperture.

b) Multiple Beam Illumination

A multiple beam illuminator has also been proposed to mitigate turbulence-induced scintillation. Several incoherent beams are transmitted through spatially separated apertures so that their footprints are overlapped at the receiving terminal. Since each beam transverses different atmospheric-turbulence profile, the corresponding scintillation patterns are uncorrelated. A summation of the scintillation patterns reduces the scintillation. The standard deviation of the resulting measured signal is reduced as σ_{I}∝1/\sqrt{N}, where N is the number of beams. This method has the following shortcomings. Fist, a limited number of beams N provides only a partial reduction of scintillation. A free space performance cannot be achieved using this technique. Second, this method requires a large aperture transmitter, or multiple spatially separated transmitters and imaging trackers, to provide statistically independent scintillation patterns in the transmitted beams. This precludes the use of this technique on a flying platform such as: UAV, aircraft, or satellite.

c) Other Methods

Other methods include the use of a diffuser to reduce turbulence-induced scintillation by creating a partially coherent beam, the use of special data communication coding techniques and adaptive threshold. These techniques can improve performance but they do not eliminate the effects of scintillation completely and do not approach free space performance. Still another approach has been suggested in U.S. Pat. No. 6,285,481. An additional “signal strength” data stream is transmitted between each pair of communicating laser transceivers. If the sensing transceiver receives “signal strength” data that indicate that the signal strength of the sending transceiver has fallen to or below a selected threshold, the sending transceiver suspends transmission of information packets. The basic shortcoming is that the information packets are not transmitted all the time. This reduces an effective data transmission rate.

The general shortcoming of all these methods is that they do not eliminate the effects of scintillation completely. When these methods are employed, scintillation still degrades the performance of the laser communication channel.

### SUMMARY OF THE INVENTION

The present invention provides a laser communication system with improved reliability and exceptionally low bit error rate. The proposed laser communication system completely eliminates the effects of turbulence and provides free space performance. These objectives are achieved by transmitting a focused laser beam to a receiver so that the focused beam waist is located entirely within the aperture of the receiver where the aperture size exceeds the effective spot size of the beam including effects of diffraction, atmospheric turbulence, and beam pointing error. In a preferred embodiment an imaging tracker at the transmitter and a laser beacon with a diverging beam at the receiver permits the transmitter to point a focusing beam accurately enough to assure that the entire beam is captured in the receiver aperture. In another embodiment a laser beam is transmitted from a first location to a modulatable retro-reflector at a second location. The beam transmitted from the first location is focused within the aperture of the retro-reflector. This beam may be sampled at the second location for communications from the first location to the second location. The retro-reflector is modulated for transmission of information from the second location to the first location. In a preferred embodiment the same antenna is used for transmission and for reception at the first location except the portion used for reception is at least twice as large as the portion used for transmission.

### BRIEF DESCRIPTION OF THE DRAWINGS

FIG. 1 shows the effect of atmospheric turbulence and SNR on BER.

FIG. 2 shows the effect of large apertures on turbulence-induced scintillation in a reflected beam.

FIGS. 3A, B and C show features of the present invention compared to prior art techniques.

FIGS. 4A and B and 5A and B show features of the present invention compared to prior art techniques.

FIG. 6A shows the main components of a transmitter receiver in a demonstration system.

FIG. 6B is a sketch of a demonstration setup to measure the BER.

FIGS. 7A and B compare test results from the demonstration setup.

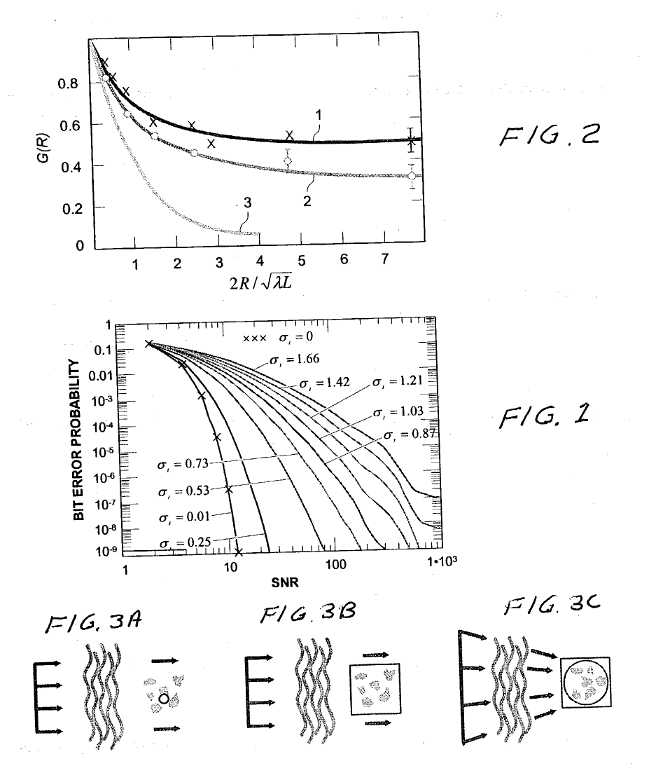

### DETAILED DESCRIPTION OF PREFERRED EMBODIMENTS

### Conservation of the Total Energy Flux During the Propagation

FIGS. 3A, B and C show the effect of the aperture diameter and beam spot size on the turbulence-induced signal variations:

FIG. A shows that signal variations for “point” receivers are seriously affected by scintillations in the incoming wave.

FIG. B shows that for a finite aperture receiver signal variations are reduced due to an aperture averaging; and

FIG. C shows that with a power in the bucket receiver, no signal variations occur as a result of turbulence.

The basic concept of the present invention is based on a fundamental property of propagation of laser irradiance in the turbulent atmosphere. That is that of conservation of the total energy flux during the propagation. In the following description we will show how by using this property one can completely eliminate the effects of turbulence on laser communication links including scintillation, turbulence-induced beam broadening, and beam wander.

The physical reason for the total energy flux to stay constant during propagation in the turbulent atmosphere is that the turbulent eddies cause a scattering of laser irradiance forward at small angles. Because the optical irradiance is scattered forward at small angles, there is no significant energy loss caused by turbulence. The turbulence just causes a redistribution of the energy in space, while the total energy flux stays approximately the same for all turbulence realizations. If the receiver acquires the total energy flux of the incoming wave, then no signal variations caused by turbulence will occur.

We will illustrate this concept by considering the following examples. When an optical wave propagates through turbulence, wavefront aberrations in the incoming wave caused by turbulent eddies over distance are converted into intensity variations called scintillation. If the receiver diameter is small, as compared to the intensity correlation scale in the incoming wave, D/2<l_{I}, as shown in FIG. 3A, then the normalized variance of the energy flux variations coincides with the normalized variance of intensity variations

$${σ}_{p}^{2} = \frac{⟨ {P}^{′ 2} ⟩}{{⟨ P ⟩}^{2}} = \frac{{( P - ⟨ P ⟩ ) )}^{2}}{{⟨ P ⟩}^{2}} = {σ}_{I}^{2} .$$

Here

$$P = {\int }_{Σ}^{} I ( ρ ) {ⅆ}^{2} ρ$$

is the energy flux recorded by the receiving aperture of diameter D, Σ=π(D/2)², P′=P− [symbol] P [symbol] is the flux variation, and the angular brackets denote statistical average. A “point” receiver does not reduce scintillation.

When the aperture diameter exceeds intensity correlation scale, D/2>l_{I}, as shown in FIG. 3B, then the received flux variance is reduced due to aperture averaging: σ_{P}²=σ_{I}²A(D), A(D)<1, where A(D) is the aperture averaging function. In the extreme case of an infinite aperture, D→∞, when the receiver acquires a total energy flux, it can be shown [1,2] that the normalized flux variance for a plane, or spherical, wave becomes equal to zero,

$${σ}_{p}^{2} = {\int }_{0}^{∞} {b}_{I} ( ρ ) ρ ⅆ ρ = 0 , \qquad ( 1 )$$

where b_{I}(ρ) is the laser irradiance spatial correlation coefficient. This is a consequence of the energy conservation law.

In the case of a space limited beam one can show that the normalized flux variance is also equals zero

$${σ}_{p}^{2} = {\int }_{0}^{{D}_{R}} {b}_{I} ( ρ ) ρ ⅆ ρ = 0 \qquad ( 2 )$$

if the receiver diameter exceeds the beam diameter in the pupil plane, D_{R}>2a_{ef}, as it is shown in FIG. 3. The effective radius of a Gaussian beam, a_{ef}, includes the effects of diffraction, turbulence, as well as pointing and focusing errors,

$${a}_{eff}^{2} = {{a}_{0}^{2} ( 1 - \frac{L}{{F}_{0}} )}^{2} + {a}_{d}^{2} + {a}_{t}^{2} + {σ}_{pe}^{2} \qquad ( 3 )$$

Here a₀ is the Gaussian beam radius at which the field amplitude is e⁻¹ of that at the beam axis at the transmitter, F₀ is the radius of beam wavefront curvature. The case F₀=∞, F₀>0 and F₀<0 correspond to collimated, convergent, and divergent beam, respectively. The diffraction and turbulent terms of the beam radius are given by

$${a}_{d} = \frac{2 L}{k {a}_{0}} and {a}_{t} = \frac{2 L}{k {ρ}_{0}} ,$$

respectively, where k=2π/λ is the wave number, and

$${ρ}_{0} = {( 1.45 {k}^{2} {\int }_{0}^{L} {C}_{n}^{2} ( η ) {( 1 - η / L )}^{5 / 3} ⅆ η )}^{- 3 / 5}$$

is the coherence radius. The pointing error term is σₚₑ=φₚₑL, where φₚₑ is the half angle rms pointing error. In the case of a focused beam

$$( \frac{L}{{F}_{0}} = 1 )$$

the effective radius of the beam has the form

a_{eff}²=σ_{F}²+a_{d}²+aₜ²+σₚₑ² (4)

where

$${σ}_{F} = ( \frac{{a}_{0}}{L} ) δ F$$

is the focusing error term, and δ F is the rms error of measuring L the range and adjusting the beam wave-front curvature to be equal to the range. In the configuration shown in FIG. 3C the receiver acquires the total energy flux of the incoming wave. Consequently, since the total energy flux stays the same for all turbulence realizations no received signal variations occur.

We propose to use the configuration shown in FIG. 3C in the laser communication systems. We consider two implementations of this concept: a) a transmitter and a receiver are located at the different terminals separated by the range, L, and b) the transmitter is collocated with the receiver at one terminal, and modulating retro-reflector is located at the second terminal.

### Proposed Method I Scintillation Free Laser Communication System Transmitter and Receiver Located at Different Terminals

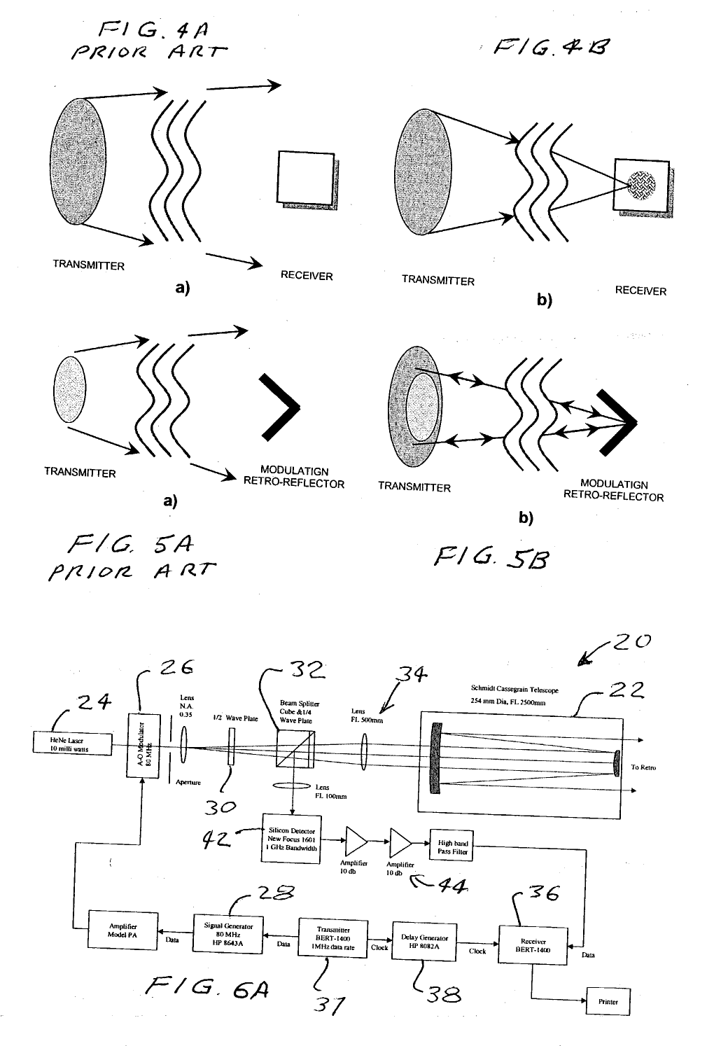

In the common laser communication systems the transmitter and the receiver are located at different terminals separated by the range L. Also traditionally in order to avoid signal dropouts caused by turbulence-induced beam wander and/or pointing error, a receiver is illuminated with a diverging beam. Typically the beam radius significantly exceeds the receiver diameter a_{ef}>>D_{R}/2. The transmitted beam and receiver configuration in a conventional laser communication system is shown FIG. 4A.

Because in the conventional scheme a receiver acquires only a portion of the total energy flux, turbulence-induced scintillation in the incoming wave causes variations of the received signal and degrade the system performance. According to FIG. 1, depending on the strength of turbulence, σ_{I}², ratio of the receiver diameter to the intensity spatial correlation scale, D_{R}/l_{I}, and signal-to-noise ratio, the bit error rate (BER) can vary over the range from 10⁻⁷ to 10⁻¹ greatly reducing the utility of the laser communication system. To provide an improved laser communication system, which has the same performance as that in a free space or in the absence of turbulence, we propose that the lasercom system configuration satisfies the following requirements:

a) the transmitted beam is focused at the receiver, or the beam wavefront curvature is equal to the range; i.e., the focal length, F, is equal to the distance between the transmitter and the receiver: F=L

b) the receiver is in the near zone of the transmitter, or the transmitting aperture radius, a₀, exceeds radius of the first Fresnel zone, a₀>\sqrt{λL}. This reduces the effect of diffraction on the transmitting beam;

c) the collecting aperture diameter, D_{R}, exceeds an effective beam diameter, 2a_{ef}, in the receiver pupil plan, D_{R}>2a_{ef};

d) the detector diameter, D_{d}, in the image plane exceeds a beam spot diameter, 2aᵢₘ, of the image, D_{d}>2aᵢₘ.

The beam and receiver geometry for the proposed laser communication system is shown in FIG. 4B. It is easy to see that when the system meets the above four requirements the receiver will acquire the total energy flux of the incoming wave, and no signal variations on the detector caused by turbulence will occur. The effects of turbulence including scintillation, turbulent beam broadening, and beam wander are completely eliminated even in the case of a long range and strong turbulence.

Depending on the application and propagation scenario, several techniques can be considered for practical implementation of this method. The first technique uses a high-bandwidth imaging tracker collocated with the transmitter and a laser beacon at the receiver to point a communication beam from the transmitter to the receiver and to stabilize the line of sight during a data transmission. A low-order adaptive optics system, in addition to an imaging tracker may be utilized to compensate for the higher-order aberrations in the transmitted beam and thus reduce the beam diameter in the pupil plane. This method can be used in ground-to-ground, ground-to-air and air to air laser communication channels.

The imaging tracker includes a focal plane imaging array, typically a CCD, or CMOS, camera, a high-speed data processor, and a fast steering mirror. The tracker acquires light from the laser beacon co-located with the receiver. A beacon illuminates the tracker with a diverging beam. The tracker forms a beacon image on the focal plane array, estimates the energy centroid position of the beacon image, and measures the difference between the line of sight to the receiver and the transmitter line of sight direction. Then through a tracking servo-loop the tracker applies this signal to the fast steering mirror to correct for the pointing error caused by the turbulence, platform motion, and vibration.

The divergence of the illuminating beacon beam and the aperture diameter of the primary mirror of the transmitting telescope provide a beacon signal level that exceeds the camera readout noise and background flux. A narrow band filter centered at the beacon laser wavelength may be use at the tracker to reduce background.

The angular accuracy of the laser tracker is determined by the camera angular pixel size, image spot size, and signal-to-noise ratio. If an angular spot size of the beacon image is less than the angular size of the pixel, then the tracker angular accuracy is determined by the angular pixel size. If the angular size of the image exceeds the pixel size and SNR>>1, then a sub-pixel resolution is achieved, and rms energy centroid error is defined by

$${σ}_{θ} = \frac{3 π}{16} \frac{1}{SNR} b \qquad ( 5 )$$

Here b is the image spot diameter (in angular units), and SNR is the signal-to-noise ratio,

$$SNR = \frac{E}{\sqrt{E + {N}_{p}^{2} {σ}_{n}^{2}}} , \qquad ( 6 )$$

E is the received energy in photo-electron per pulse, Nₚ is the number of pixels in one dimension of the camera, and σₙ is the rms noise per pixel in photo-electrons. The full-width-at-half-maximum of the short-exposure spot in the image plane is

b=0.477λ/r₀ (7)

In order to correct for the turbulence-induced jitter, a closed loop tracker should meet the following requirements: a) the closed loop bandwidth must be 3-4 times greater than the Greenwood frequency

$${f}_{b} = {f}_{G} = {( 0.102 {k}^{2} {\int }_{0}^{L} {C}_{n}^{2} ( z ) {V}^{5 / 3} ( z ) ⅆ z )}^{3 / 5} \qquad ( 8 )$$

where V(z) is the wind velocity, or beam slew rate, and b) the camera frame rate should exceed the closed-loop bandwidth by a factor of 10. For example, if the Greenwood frequency is f_{G}=40 Hz, then the closed-loop bandwidth is f_{b}=160 Hz, and the required camera frame rate is f_{f}=1.6 kHz.

In the case of two stationary terminals the proposed system operates as the following. First, the imaging tracker at the transmitter acquires the light from the laser beacon co-located with the receiver and initiates a closed-loop tracking. Second, a communication beam is transmitted to the receiver located in the near zone of the transmitter. The transmitted light is collected within a receiver aperture (preferably a lens or a mirror) which focuses all of the collected light onto a detector. The range between the terminals is measured and the radius of beam wavefront curvature is adjusted to be equal to the range, F₀=L, the receiver aperture diameter should exceed an effective size of the beam at the receiver aperture, and the detector diameter should exceed the imaged beam spot diameter in the image plane. This reduces the effects of scintillation to nearly zero. To establish a two-way communication, both terminals must be equipped with the laser beacons, imaging trackers, and transmitters/receivers.

In the case of moving platforms, the range between the transmitter and receiver changes. The range between two platforms is measured. To measure the range, a laser range finder is used. Based on the range measurements, the radius of beam wavefront curvature is adjusted in nearly real time to be equal to the range, F₀=L. So, that the beam waist is located at the receiver.

This system architecture allows us to reduce the effect of scintiilation and increase the SNR as compared to prior art systems and achieve a very low BER using a low power laser. In addition, the proposed scheme reduces the impact of laser attenuation in the atmosphere caused by haze, smoke, and light fog, because no energy losses occur due to selected transmit/receive configuration, and the total energy flux is acquired.

### Proposed Method II Scintillation Free Laser Communication Link with a Modulating Retro Reflector

A modulatable retro-reflector (MRR) has been developed by group of researchers at the United States Navy Research Laboratory (NRL) to be used at a flying platform, such as unmanned aviation vehicle (UAV). The MRR eliminates the need for a second laser, second telescope, and second pointer/tracker on a flying platform and provides a means for transfering data from air/space to ground by using a compact, low-power system. A laser beam from a ground transmitter interrogates a retroreflector, which is coupled with a multiple quantum well modulator. The retro-reflected beam returns modulated light carrying information to the ground transmitter/receiver site, where this light is demodulated to extract the information.

In the conventional scheme the MRR is illuminated with a diverging beam, as shown in FIG. 5A. A diverging beam reduces the effects of a pointing error and turbulence induced beam wander on a tracker. The MRR acquires, modulates and reflects back to the ground receiver a small portion of the incoming energy flux and the ground receiver records the modulated reflected signal. This scheme has two fundamental shortcomings. First, only a small portion of incoming energy flux is retro-reflected back. This reduces the SNR and greatly limits an operational range. Second, turbulence-induced scintillation causes signal fades and in conjunction with reduced SNR increases a bit-error-rate. Thus, the system performance is degraded by both SNR loss and scintillation.

For a small MRR, the received power in the far filed of the retro-reflector is proportional to

$$\frac{{P}_{laser} {D}_{retro}^{4} {D}_{rec}^{2} {T}_{cl}^{2} {T}_{atm}^{2}}{{θ}_{div}^{2} {R}^{4}} \qquad ( 5 )$$

where Pₗₐₛₑᵣ is the transmit power, Dᵣₑₜᵣₒ is the diameter of the retroreflector, D_{rec} is the receiver diameter, Tₐₜₘ is the transmission coefficient of the atmosphere, T_{cl} is the transmission coefficient of the clouds, θ_{div} is the divergence of the transmit beam, and R is the range.

If Tₐₜₘ=T_{cl}=1, Dᵣₑₜᵣₒ=2.5 cm, D_{rec}=0.3 m, and θ_{div}=12.5 mrad, then at the range of R=1 km, the ratio of the received power to the transmitted power is

$$\frac{{P}_{rec}}{{P}_{laser}} = 2.24 \times {10}^{- 16} ,$$

whereas at the range of R=10 km this ratio is

$$\frac{{P}_{rec}}{{P}_{laser}} = 2.24 \times {10}^{- 20} .$$

Thus, a conventional scheme results in tremendous power loss. This limits the operational range and increases bit-error-rate. The proposed method reduces this energy loss to nearly zero.

In addition, due to residual turbulence scintillation effect, turbulence-induced scintillation causes signal fades and further increases a bit-error-rate. To provide an improved laser communication system with an MRR, and reduce two key degradadtion effects: a) laser energy loss, and b) turbulence-induced scintillation. Applicant has developed the following system architecture. The transmitter illuminates an MRR with two laser beams: a) a diverging tracking beam and b) a focused communication beam. The range between the transmitter and modulating RR is measured and the radius of wavefront curvature of the communication beam is adjusted in near real time to be equal to the range, F₀=L. The transmitter, the MRR, and the receiver preferably satisfy the following requirements:

a) The transmitted beam is focused at the MRR, or the beam wavefront curvature is equal to the range, F=L;

b) The retro-reflector is in the near zone of the transmitter, or the transmitting aperture radius exceeds radius of the first Fresnel zone, a₀>\sqrt{λL}. This reduces the effect of diffraction on the transmitting beam;

c) The communication beam is transmitted through a portion of the primary mirror of the receiving telescope. So, that the transmitting aperture diameter is as small or smaller than one half the receiving aperture diameter, D_{T}≦D_{R}/2;

d) The retro-reflector diameter exceeds an effective diameter of the transmitted beam at the retro-reflector, D_{RR}>2a_{ef};

e) The collecting aperture diameter exceeds an effective diameter of the reflected beam in the receiver pupil plan, D_{R}>2a_{ef}; and

f) The detector diameter in the image plane of the receiving telescope exceeds a beam spot diameter of the RR image, D_{d}>2a_{Im}.

The transceiver is equipped with a high-bandwidth imaging tracker to accurately measure the angular position of the MRR and point a communication beam. It also has a range tracker to measure the range and adjust the wave-front curvature of the communication beam.

If the MRR is on a moving platform, then the system operates as following. First, the transmitter illuminates the MRR with a diverging tracker beam. A tracker beam is retro-reflected back and acquired with an imaging tracker. A closed-loop tracking is initiated. Second, a laser range finder measures the range between the transceiver and MRR. The radius of the wave front curvature of the communication beam is set to be equal to the range, F₀=L, so the beam is focused onto the MRR. The focused communication beam is transmitted to the MRR. A retro-reflected beam is acquired with the received telescope, and a two-way communication is established. Parameters of the transmitting beam, transmitting and receiving telescope, MRR, and detector satisfy the conditions a)-f). This allows us to perform a two-way communication with exceptionally low BER that corresponds to the system performance in a free space. Alternatively, instead of the laser range finder, a measured time delay between the transmitted and received pulses of the communication beam can be used to determine the range between the transceiver and modulating RR and adjust the radius of wavefront curvature of the communication beam. Also the range between the transceiver and MRR can be determined by using Global Positioning System.

It is easy to see that when the system meets the above requirements a)-f), the receiver acquires the total energy flux in the beam as it arrives at the receiver. This completely eliminates the SNR loss caused by a divergence of the communication beam and small size of the MRR. In addition, this completely eliminates signal fades on the detector caused by scintillation. Even in the case of a long range and strong turbulence, the effects of turbulence on the system performance including scintillation, beam broadening and beam wander are eliminated. This increases an operational range and utility of the communication system, as well as assuring an exceptionally low BER using a system with a low power laser. Performance with the present invention in the atmosphere corresponds to the system performance in a free space. In addition, the proposed scheme reduces an impact of laser attenuation in the atmosphere caused by haze, smoke, and light fog.

Thus, the basic features of preferred embodiment of the present invention are the following:

transmit two beams a) a track beam and b) a communication beam

measure the range between the terminals (or between the transceiver and MRR);

adjust the wave front curvature of the communication beam to be equal to the range;

transmit the communication beam through a portion of the primary mirror of the receiver so that the receiving aperture diameter exceeds aperture diameter of the transmitter

reflect the beam from the MRR which dimension exceeds an effective diameter of the communication beam

receive a retro-reflected beam with the receiver which exceeds the diameter of the retro-reflected beam

detect received signal in the image plane of the receiving telescope with a detector, which exceeds the diameter of the image.

### Experimental Validation of the Proposed Method

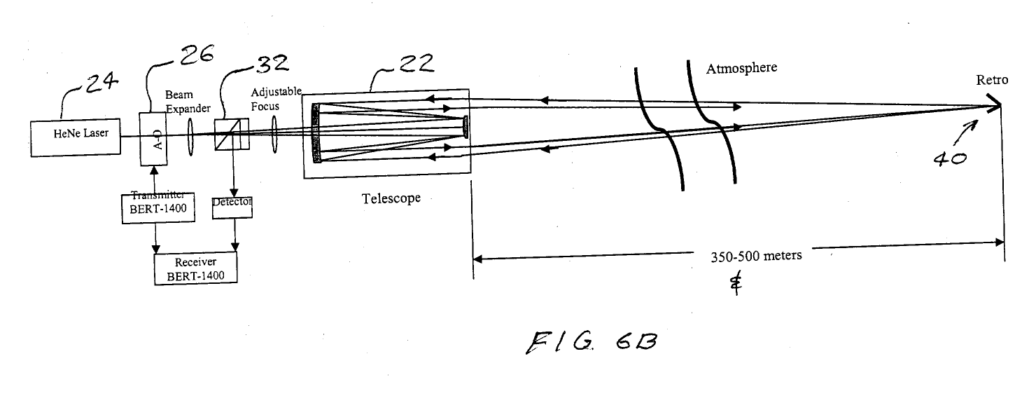

Validation of the proposed methods was demonstrated by Applicant using a retro-reflector separated from the transmitter-receiver by a distance of L=350 m in one test and 500 m in another test. The schematic drawing of the transmitter/receiver is shown in FIG. 6A. FIG. 6B is a drawing of the test layout shownig the transmitter-receiver 20 and the retro-reflector (RR) 40. The reader should note that only about half of the aperture of telescope 22 is used to transmit the beam to the RR whereas substantially the entire aperture is used to receive the retro-reflected beam. The measurements were performed using a 10 mW HeNe laser 24 and a Schmidt-Cassegrain 25.4 cm telescope 22 with a focal length of 250 cm at the transmitter-receiver. An acousto-optical modulator 26 was used to modulate the beam at a modulating frequency was 1 MHz.

A ½ wave plate 30 was used to obtain a linearly polarized beam. After passing through a beam splitter cube and ¼ wave plate unit 32, the beam was circular polarized. The reflected beam had inverse circular polarization. A 500 mm lens 34 was used to focus the beam at the retro-reflector. Two retro-reflectors 40 having diameter of 2.54 cm and 5.8 cm have been use in the test.

A transmitted pulse was generated at transmitter 37 of a bit-error-rate counter (BERT) 36 and sent to signal generator 28 for an acousto-optical (A-O) modulator 26. An amplified signal was applied to the AO modulator to modulate the laser irradiance with a 1 MHz rate. A portion of the signal transmitted to the RR was sent though the delay line 38 (to compensate for the propagation time delay) to bit-error-rate counter 36 to be compared with the retro-reflected pulse coming back to telescope 22 and picked off by beam splitter 32.

The modulated laser beam transmitted from unit 20 to RR 40 was transmitted from only a portion of the primary mirror, D_{T}≦D_{R}/2, and focused at the retro-reflector. The beam diameter at the retro-reflector at nighttime and daytime did not exceed 2 cm. A retro-reflected beam was collected by the substantially all of primary mirror of the Schmidt Cassegrain telescope using the full DR. The collecting aperture diameter exceeded an effective diameter of a retro-reflected beam in the pupil plan, D_{R}>2a_{ef}.

A received signal was detected by the detector 42 and amplified in amplifier 44. Then a retro-reflected pulse was sent to the bit-error-rate counter 36 and compared with the transmitted pulse. The number of errors during a given time interval was calculated, and the BER was estimated. The measurements were performed when the beam was focused at RR 40, and both at nigh and at daytime under various atmospheric conditions, including clear sky, partial clouds, haze, and light fog.

Some sample test results, which include the number of recoded errors during a given time period and estimated BER when the beam was focused at the retro-reflector and when a known amount of defocus was intentionally introduced is given in Table 1.

TABLE I

| | | |
|---|---|---|
| Time Interval | Number of Errors | Bit-Error-Rate |

Focused Beam

| | | |
|---|---|---|
| 11 min | 0 | 0.0 × 10⁻⁸ |
| 30 min | 3 | 2 × 10⁻⁹ |
| 20 min | 0 | 0.0 × 10⁻⁹ |
| 25 min | 1 | 7.0 × 10⁻¹⁰ |
| 15 min | 0 | 0.0 × 10⁻⁸ |
| 29 min | 0 | 0.0 × 10⁻⁹ |
| 23 min | 0 | 0.0 × 10⁻⁹ |

De-focused Beam

| | | |
|---|---|---|
| 1 min | 101,587 | 1.7 × 10⁻³ |
| 1 min | 15,638 | 2.6 × 10⁻⁴ |
| 1 min | 22,228 | 3.7 × 10⁻⁴ |
| 1 min | 255,643 | 4.3 × 10⁻³ |

The data in Table 1 confirm that by using the proposed system one can eliminate the effect of turbulence and reduce the BER by several orders of magnitude.

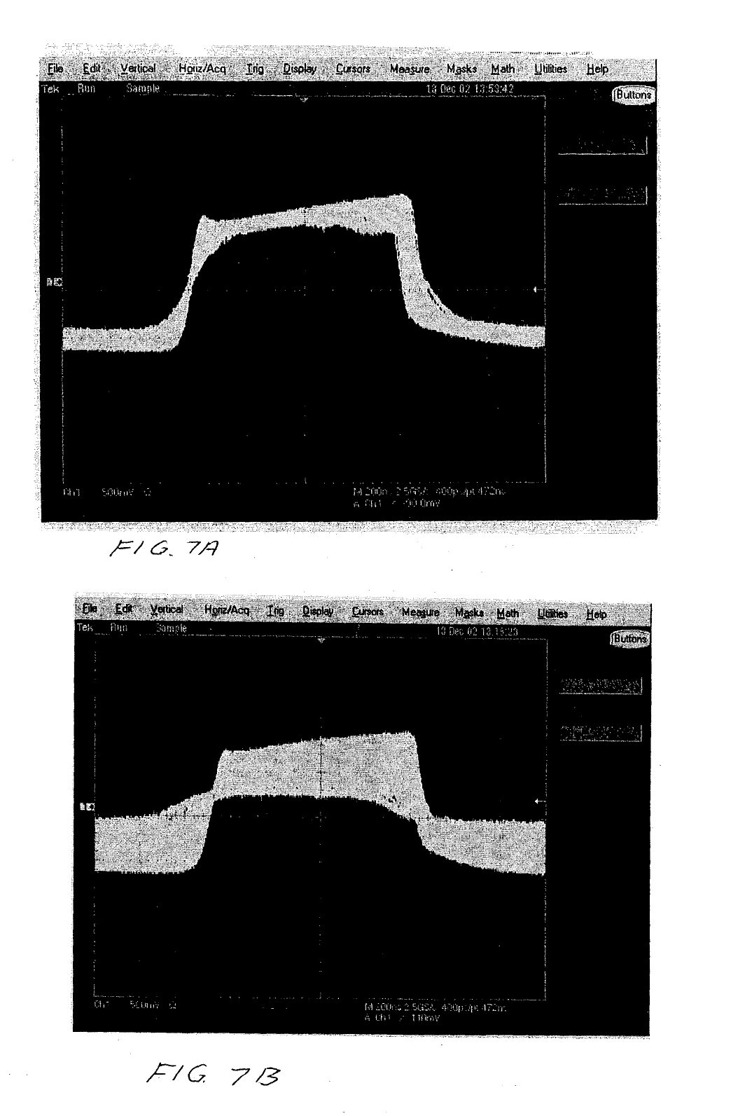

FIGS. 7A and B show an eye patterns of received signals for a conventional (on the right) and proposed system architecture (on the left). These plots were generated by the overlay of N=3 10⁸ traces from an oscilloscope triggered in phase with the clock of the BER pattern generator. FIG. 7A corresponds to a focused beam, whereas FIG. 7B corresponds to a defocused beam. The width of the integrated pulse characterizes the signal variation during a 5-min period. If no signal variations occur during the integration period, then all the received pulses would be on a top of each other, and the width of the integrated pulse would be minimal. It is also seen that the signal variations increase when a known amount of defocus was intentionally introduced in the transmitted beam. This validates the proposed concept.

While various preferred embodiments of the present invention are described in detail above, the reader should not construe these descriptions as limitations on the invention. For example, many changes and modifications could be made within the scope of the present invention. Many lasers other than the He-Ne referred to above could be substituted. The diode lasers operating at 810 nanometer, or 1550 nanometer, wavelength in most cases would be the preferable choose. Other telescopes could be used to focus the beam and to collect return signals. In addition, hundreds of well-known techniques currently being used for laser communication could be applied in connection with the novel ideas described above. The range to the MRR can be determined by dithering the focus of the telescope system and looking for the maximum return signal. GPS positioning which can determine positions within a few centimeters can be used to point the transmitter beams. Two closed tracking loops may be needed especially when one or both of the stations are moving.

Therefore, the reader should determine the scope of the present invention from the claims and their legal equivalents.

What is claimed is:

1. A free space laser communication link comprising:
A) a first laser communication station at a first location, said first station comprising a first communication laser receiver, said receiver defining a receive aperture;
B) a second laser communication station at a second location separated by at least 100 meters of atmosphere from said laser communication station, said second station comprising a first laser transmitter unit comprising:
1) a first laser for producing a communication laser beam,
2) a telescope system comprising focusing optics for focusing said communication laser beam at said first location to a focal waist smaller than said receive aperture,
C) a tracking and pointing means for tracking said receive aperture and pointing said telescope to said receive aperture so that all or substantially all of said communication laser beam arriving at the first station is directed into said receive aperture.

2. The link of claim 1 wherein said telescope system further comprises a Cassegrain

3. The link of claim 1 wherein said focusing optics comprise at least one lens.

4. The link of claim 1 wherein said first laser is a diode laser

5. The link of claim 1 and further comprising a modulator for modulating said communication laser beam so as to transmit information from said second station to said first station.

6. The link of claim 1 wherein said pointing and tracking means comprises a second laser located at said first station for producing a beacon laser beam directed toward said second station.

7. The link of claim 6 wherein said beacon laser beam is a diverging laser beam.

8. The link of claim 5 wherein said first communication receiver comprises a modulatable retro-reflector.

9. The link of claim 8 wherein said first station also comprises a modulation means for modulating said modulatable retro-reflector.

10. The link of claim 8 wherein said telescope system comprises a single telescope means for transmitting said communication laser beam to said modulatable retro-reflector and for collecting laser beams reflected from said modulatable retro-reflector.

11. The link of claim 8 wherein only a first portion of an aperture of said single telescope is used for transmitting said communication laser beam to said modulatable retro-reflector and a larger portion or all of said aperture of said telescope is used for collecting laser beams reflected from said modulatable retro-reflector.

12. The link of claim 11 wherein said first portion is about half.

13. The link of claim 12 wherein said second station also comprises a detector and a focusing means for imaging light reflected from said modulatable retro-reflector and collected by said single telescope onto said detector to produce an image on said detector.

14. The link of claim 13 wherein said detector is at least as large as said image.

15. The link of claim 8 wherein:
A) the first communication laser beam is focused at a said first station,
g) the telescope system defines a transmitting aperture radius that exceeds radius of a first Fresnel zone,
h) the telescope system defines a transmitting aperture diameter and a receive aperture diameter and said transmitting aperture is as small or smaller than one half the receiving aperture diameter, D_{T}≦D_{R}/2;
i) said modulatable retro-reflector defines an effective diameter exceeds an effective diameter of the communication laser beam at the retro-reflector, D_{RR}>2a_{ef};
j) the receive aperture diameter of the telescope system exceeds an effective diameter of the reflected beam in a pupil plan of the telescope system, D_{R}>2a_{ef}; and
k) said second station further comprises a detector defining an image plane with an effective diameter in the image plane of the receiving telescope exceeds an effective beam spot diameter of the modulatable retro-reflector image, D_{d}>2a_{Im}.

16. A free space laser communication system comprising:
A) a first communication laser receiver at a first location, said first receiver defining a first receive aperture;
B) a first laser transmitter unit at a second location separated by at least 100 meters of atmosphere from said laser receiver, said first laser transmitter unit comprising:
1) a first laser for producing a first communication laser beam,
2) a first telescope system comprising focusing optics for focusing said first communication laser beam at said first location to a focal waist smaller than said first receive aperture,
C) a first tracking and pointing means for tracking said first receive aperture and pointing said first telescope to said first aperture so that all or substantially all of said first communication laser beam arriving at the first location is directed into said first receive aperture;
D) a second communication laser receiver at said second location, said second receiver defining a second receive aperture;
E) a second laser transmitter unit at said first location, said second laser transmitter unit comprising:
1) a second laser for producing a second communication laser beam,
2) a second telescope system comprising focusing optics for focusing said second communication laser beam at said second location to a focal waist smaller than said second receive aperture,
F) a second tracking and pointing means for tracking said second receive aperture and pointing said second telescope to said second aperture so that all or substantially all of said second communication laser beam arriving at the second location is directed into said second receive aperture.

17. The system of claim 16 wherein said first telescope system comprise a Cassegrain telescope defining a first Cassegrain telescope and said second telescope system comprises a Cassegrain telescope defining a second Cassegrain telescope.

18. The system of claim 17 wherein said first Cassegrain telescope defines said second receive aperture and said second Cassegrain telescope defines said first receive aperture.

19. The system of claim 18 wherein said first tracking and pointing means comprise a beacon laser at said first location producing a diverging beacon laser beam directed at said second location and said second tracking and pointing means comprise a beacon laser at said second location producing a diverging beacon laser beam directed at said first location.

20. A method for reducing transmission error and achieving exceptionally low bit-error rate in a free-space laser communication system comprising a laser transmitter at a first station and a laser receiver at a second station in the presence of turbulence comprising the steps of:
a) initiating a closed loop tracking at said first station of a receiver at said second station using an imaging tracker at said first station and a laser beacon at the second station with a diverging beam,
b) measuring range between the transmitter and receiver,
c) focusing a laser beam of a laser at said first station so that a beam waist of said laser beam defining a spot size is located within a collecting aperture of the receiver;
d) transmitting a focused laser beam to the receiver,
e) receiving the transmitted beam at the receiver wherein the spot size of the beam in a pupil plane of the receiver includes the effects of diffraction, atmospheric turbulence, and beam pointing error,
f) imaging the transmitted beam at an image plane on a detector larger than the image of a transmitted laser beam,
g) analyzing signals from said detector to obtain information transmitted in said laser beam.

21. The method of claim 20, further including the steps of:
A) transmitting a focusing laser beam through a portion of a primary mirror, defining D_{T} and D_{R} where D_{T}≦D_{R}/2 and D_{T} and D_{R};
B) reflecting the transmitting focused beam from a retro-reflector having the dimension, which exceeds the beam spot size in the retro-reflector plane that includes the diffraction, effects of turbulence, and pointing error;
C) receiving a retro-reflected signal with a receiver collocated with the transmitter so that the receiver diameter exceeds the spot size of the reflected beam in the receiver pupil plane, which includes the effects of diffraction, turbulence, and pointing error;
D) detecting the retro-reflected signal in the receiver image plane using a detector having a diameter, which exceeds the spot size of the image of a retro-reflector degraded by turbulence and non perfect optics (image blur and image motion); and
E) using an imaging tracker with a diverging laser beam to accurately point a focusing beam at the retro-reflector;

22. A system for high data rate communication with exceptionally low bit-error rate in the presence of turbulence using low power laser comprising:
A) a receiver at a first station said receiver defining a receive aperture,
B) a transmitter comprising a telescope and having means for pointing and focusing a communication laser beam within said receive aperture;
C) a detector defining a detection aperture;
D) a focusing means for focusing laser light collected within said aperture onto said detector into a image spot smaller than said detection aperture wherein said image spot is within said detection aperture, and
E) an imaging tracker coupled with said transmitter for tracking said receiver and pointing the communication beam at the receiver.

23. The link of claim 1 wherein said tracking and pointing means comprises GPS units.

24. The link of claim 8 wherein said tracking and pointing means comprises GPS units.

25. The system of claim 16 wherein said tracking and pointing means comprise GPS units.

26. The method of claim 20 wherein range is determined by dithering a focus.

27. The method of claim 21 wherein range is determined by dithering a focus.
